(19) United States
(12) Patent Application Publication
(10) Pub. No.: US 2018/0072914 A1
(43) Pub. Date: Mar. 15, 2018

(54) HARD COATING FILM AND IMAGE DISPLAY DEVICE HAVING THE SAME

(71) Applicant: DONGWOO FINE-CHEM CO., LTD., Iksan-si (KR)

(72) Inventors: Sung Min KIM, Incheon (KR); Kwanwook SONG, Pyeongtaek-si (KR)

(73) Assignee: DONGWOO FINE-CHEM CO., LTD., Iksan-si (KR)

(21) Appl. No.: 15/687,642

(22) Filed: Aug. 28, 2017

(30) Foreign Application Priority Data
Sep. 12, 2016 (KR) 10-2016-0117339

(51) Int. Cl. C09D 175/16; C08J 7/04; B05D 7/00

(52) U.S. Cl. CPC C09D 175/16; C08J 7/042; C08J 2475/16; C08J 2379/08; B05D 7/52

(57) ABSTRACT

A hard coating film is provided. The hard coating film includes: a substrate; a first hard coating layer formed on one surface of the substrate; and a second hard coating layer formed on the other surface of the substrate, wherein the first hard coating layer has a corrected breaking strength of 50 to 500 MPa. and an image display device having the hard coating film. The hard coating film has excellent impact resistance as well as excellent bending resistance.

### TECHNICAL FIELD

The present invention relates to a hard coating film and an image display device having the same. More particularly, the present invention relates to a hard coating film having excellent impact resistance as well as excellent bending resistance, and an image display device having the hard coating film.

### BACKGROUND ART

A hard coating film has been used for protecting the surface of various image display devices including a liquid crystal display device (LCD), an electroluminescence (EL) display device, a plasma display (PD), a field emission display (FED) and the like.

Recently, a flexible display device which can maintain display performance even when it is bent like a paper by using a flexible material such as plastic, instead of a conventional glass substrate having no flexibility, gains attention as a next generation display device. In this regard, there is a need for a hard coating film which not only has high hardness and good scratch resistance but also has proper flexibility so that cracks do not occur, without curling at the film edges during its production or use.

Korean Patent Application Publication No. 2014-0027023 discloses a hard coating film which comprises a supporting substrate; a first hard coating layer formed on one surface of the substrate and comprising a first photocurable cross-linked copolymer; and a second hard coating layer formed on the other surface of the substrate and comprising a second photocurable cross-linked copolymer, and inorganic particles distributed in the second photocurable cross-linked copolymer, and the hard coating film exhibits high hardness, impact resistance, scratch resistance, and high transparency.

However, such a hard coating film having high hardness has a problem that it does not have sufficient bending resistance.

### DISCLOSURE

### Technical Problem

It is an object of the present invention to provide a hard coating film having excellent impact resistance as well as excellent bending resistance.

It is another object of the present invention to provide an image display device having the hard coating film.

### Technical Solution

In accordance with one aspect of the present invention, there is provided a hard coating film, comprising:

a substrate;

a first hard coating layer formed on one surface of the substrate; and

a second hard coating layer formed on the other surface of the substrate,

wherein the first hard coating layer has a corrected breaking strength defined by the following Equation 1 of 50) to 500 MPa:

Corrected Breaking Strength (MPa)=Elastic Modulus (MPa)×Breaking Elongation (%)× 1/100 [Equation 1]

wherein,

the elastic modulus represents the modulus of elasticity in the stress-strain curve, and

the breaking elongation represents the elongation at break in the stress-strain curve.

In one embodiment of the present invention, the first hard coating layer may be formed from a first hard coating layer-forming composition including a urethane acrylate oligomer, a photoinitiator and a solvent.

In one embodiment of the present invention, the second hard coating layer may be formed from a second hard coating layer-forming composition including a photocurable resin, inorganic nanoparticles, a photoinitiator and a solvent.

In accordance with another aspect of the present invention, there is provided an image display device having the hard coating film.

### Advantageous Effects

The hard coating film according to the present invention is excellent in impact resistance and also has excellent bending resistance, and thus it can be effectively used for a window of a flexible display device.

### BEST MODE

Hereinafter, the present invention will be described in more detail.

One embodiment of the present invention relates to a hard coating film, comprising:

a substrate:

a first hard coating layer formed on one surface of the substrate; and

a second hard coating layer formed on the other surface of the substrate,

wherein the first hard coating layer has a corrected breaking strength defined by the following Equation 1 of 50 to 500 MPa:

Corrected Breaking Strength (MPa)=Elastic Modulus (MPa)×Breaking Elongation (%)× 1/100 [Equation 1]

wherein,

the elastic modulus represents the modulus of elasticity in the stress-strain curve, and

the breaking elongation represents the elongation at break in the stress-strain curve.

The stress-strain curve can be used interchangeably with terms such as a stress-strain graph, a stress-strain diagram and the like. The stress-strain curve can be obtained by measuring the load applied to the specimen of a material and the strain. For example, it can be measured and derived using a universal testing machine (UTM) according to ASTM D 882.

The elastic modulus is a value indicating the rigidity of the material and is also called an elastic coefficient. The elastic modulus is defined as the ratio between the stress and strain in the elastic region and can be determined from the slope of the elastic region of the stress-strain curve obtained by the tensile test of the specimen of the material.

The breaking elongation is an amount of elongation until the material breaks under a specific controlled condition, and is expressed in %. The breaking elongation can be the value of strain at break in the stress-strain curve.

The hard coating film according to one embodiment of the present invention has a first hard coating layer having a corrected breaking strength of 50 to 500 MPa. and thus can secure both impact resistance and bending resistance. If the corrected breaking strength is less than 50 MPa, the material is soft and has a large elongation, and thus an impact load can be effectively absorbed when an impact such as a ball drop occurs. However, due its low elastic modulus, hit marks may remain on the second hard coating layer or cracks can occur due to a permanent deformation in the bending resistance test at high temperature and high humidity. On the other hand, if the corrected breaking strength exceeds 500 MPa, the material has a high elastic modulus, and thus an impact load cannot be absorbed and can be directly transferred to the lower structure when an impact such as a ball drop occurs, so that the screen display substrate or the like disposed in the lower structure can be broken.

In one embodiment of the present invention, the first hard coating layer may be formed from a first hard coating layer-forming composition including a urethane acrylate oligomer, a photoinitiator and a solvent.

The urethane acrylate oligomer can be prepared by subjecting an isocyanate compound having two or more isocyanate groups in the molecule and an acrylate compound having one or more hydroxy groups in the molecule to urethane reaction.

Specific examples of the isocyanate compound may include tri-functional isocyanates derived from 4,4′-dicyclohexyl diisocyanate, hexamethylene diisocyanate, 1,4-diisocyanatobutane, 1,6-diisocyanatohexane, 1,8-diisocyanatooctane, 1,12-diisocyanatododecane, 1,5-diisocyanato-2-methylpentane, trimethyl-1,6-diisocyanatohexane, 1,3-bis(isocyanatomethyl)cyclohexane, trans-1,4-cyclohexene diisocyanate, 4,4′-methylenebis(cyclohexyl isocyanate), isophorone diisocyanate, toluene-2,4-diisocyanate, toluene-2,6-diisocyanate, xylene-1,4-diisocyanate, tetramethylxylene-1,3-diisocyanate, 1-chloromethyl-2,4-diisocyanate, 4,4′-methylenebis (2,6-dimethylphenyl isocyanate), 4,4′-oxybis(phenylisocyanate), hexamethylene diisocyanate, and an adduct of trimethylol propane and toluene diisocyanate, and these may be used alone or in combination of two or more.

Specific examples of the acrylate compound having a hydroxyl group may include 2-hydroxyethyl acrylate, 2-hydroxyisopropropyl acrylate, 4-hydroxybutyl acrylate, caprolactone ring-opened hydroxyacrylate, a mixture of pentaerythritol tri/tetraacrylate, a mixture of dipentaerythritol penta/hexaacrylate, and these may be used alone or in combination of two or more.

The urethane acrylate oligomer may be, for example, a bifunctional urethane acrylate oligomer. Commercial products of the bifunctional urethane acrylate oligomer include CN9002, CN910A70, CN9167, CN9170A86, CN9200, CN963B80, CN964A85, CN965, CN966H90, CN9761, CN9761A75, CN981, CN991, CN996 (available from Sartomer Arkema), UF8001G, UF8002G, UF8003G, DAUA-167 (available from KYOEISA Chemical), SC2404, SC2565, PU-2560, UA-5210 (available from Miwon Specialty Chemical), and UA-122P, UA-232P (available from Shin Nakamura Chemical). These may be used alone or in combination of two or more.

The urethane acrylate oligomer may be contained in an amount of 1 to 90% by weight, for example 5 to 85% by weight, based on 100% by weight of the total weight of the first hard coating layer-forming composition. When the amount of the oligomer is less than 1% by weight, sufficient impact resistance cannot be obtained. When the amount of the oligomer is higher than 90% by weight, it may be difficult to form a uniform cured coating film due to its high viscosity.

The photoinitiator can be used without particular limitation as long as it is an initiator being used in the art. The photoinitiator can be classified into a Type I photoinitiator in which radicals are generated by decomposition of molecules due to a difference in chemical structure or molecular binding energy, and a Type II (hydrogen abstraction type) photoinitiator in which tertiary amines are incorporated as a co-initiator. Specific examples of the Type I photoinitiator may include acetophenones such as 4-phenoxydichloroacetophenone, 4-t-butyldichloroacetophenone, 4-t-butyltrichloroacetophenone, diethoxyacetophenone, 2-hydroxy-2-methyl-1-phenylpropan-1-one, 1-(4-isopropylphenyl)-2-hydroxy-2-methylpropan-1-one, 1-(4-dodecylphenyl)-2-hydroxy-2-methylpropan-1-one, 4-(2-hydroxy ethoxy)-phenyl(2-hydroxy-2-propyl)ketone, 1-hydroxycyclohexyl phenyl ketone or the like, benzoins such as benzoin, benzoin methyl ether, benzoin ethyl ether, benzyl dimethyl ketal or the like, acylphosphine oxides, and titanocene compounds. Specific examples of the Type II photoinitiator may include benzophenones such as benzophenone, benzoyl benzoic acid, benzoyl benzoic acid methyl ether, 4-phenylbenzophenone, hydroxybenzophenone, 4-benzoyl-4′-methyldiphenylsulfide, 3,3′-dimethyl-4-methoxybenzophenone or the like, and thioxanthones such as thioxanthone, 2-chlorothioxanthone, 2-methylthioxanthone, 2,4-dimethylthioxanthone, isopropylthioxanthone or the like. These photoinitiators may be used alone or in combination of two or more. In addition, Type I photoinitiator and Type II photoinitiator can be used alone or in combination.

The photoinitiator may be used in an amount sufficient to proceed photopolymerization and may be used in an amount of 0.1 to 10% by weight, for example, 1 to 5% by weight based on 100% by weight of the total weight of the first hard coating layer-forming composition. If the amount of the photoinitiator is less than 0.1% by weight, the curing does not proceed sufficiently and thus it is difficult to realize the mechanical properties or adhesive force of the finally obtained hard coating film. If the amount of the photoinitiator exceeds 10% by weight, adhesion failure or cracking and curling phenomena can occur due to curing shrinkage.

The solvent may be used without particular limitation as long as it is used in the art. Specific examples of the solvent may include alcohols (methanol, ethanol, isopropanol, butanol, propylene glycol methoxy alcohol, etc.), ketones (methyl ethyl ketone, methyl butyl ketone, methyl isobutyl ketone, diethyl ketone, dipropyl ketone, etc.), acetates (methyl acetate, ethyl acetate, butyl acetate, propylene glycol methoxy acetate, etc.), cellosolves (methyl cellosolve, ethyl cellosolve, propyl cellosolve, etc.), hydrocarbons (normal hexane, normal heptane, benzene, toluene, xylene, etc.) and the like. These solvents may be used alone or in combination of two or more.

The solvent may be contained in an amount of 5 to 90% by weight, for example 20 to 70% by weight, based on 100% by weight of the total weight of the first hard coating layer-forming composition. If the amount of the solvent is less than 5% by weight, the viscosity may increase to deteriorate workability. If the amount of the solvent is higher than 90% by weight, it is difficult to adjust the thickness of the coating film, and drying unevenness occurs, resulting in appearance defects.

The first hard coating layer-forming composition may further include, in addition to the above-mentioned components, components commonly used in the art such as a leveling agent, an ultraviolet stabilizer, a heat stabilizer, and the like.

The leveling agent can be used in order to provide the smoothness and coating property of a coating film during coating of the first hard coating layer-forming composition. As the leveling agent, silicon-type, fluorine-type and acrylic polymer-type leveling agents being commercially available may be used. For example, BYK-323, BYK-331, BYK-333, BYK-337. BYK-373, BYK-375, BYK-377, BYK-378, BYK-3570, BYK-UV 3570 (available from BYK Chemie), TEGO Glide 410, TEGO Glide 411, TEGO Glide 415, TEGO Glide 420, TEGO Glide 432, TEGO Glide 435, TEGO Glide 440, TEGO Glide 450, TEGO Glide 455, TEGO Rad 2100, TEGO Rad 2200N, TEGO Rad 2250, TEGO Rad 2300, TEGO Rad 2500 (available from Degussa), FC-4430, FC-4432 (available from 3M), or the like may be used. The leveling agent may be contained in an amount of 0.1 to 3% by weight based on 100% by weight of the total weight of the first hard coating layer-forming composition.

Since the surface of the cured coating film is decomposed by continuous ultraviolet ray exposure to be discolored and crumbled, the ultraviolet stabilizer may be added for the purpose of protecting the coating film by blocking or absorbing such ultraviolet rays. The ultraviolet stabilizer may be classified into an absorbent, a quencher and a hindered amine light stabilizer (HALS) depending on the action mechanism. Also, it may be classified into phenyl salicylate (absorbent), benzophenone (absorbent), benzotriazole (absorbent, nickel derivative (quencher) and radical scavenger depending on the chemical structure. In the present invention, the ultraviolet stabilizer can be used without particular limitation as long as it is an ultraviolet stabilizer that does not significantly change the initial color of the coating film.

The heat stabilizer is a product that can be applied commercially, and a polyphenol type which is a primary heat stabilizer, a phosphite type which is a secondary heat stabilizer, and a lactone type can be used each individually or in combination thereof.

The ultraviolet stabilizer and the heat stabilizer can be used by appropriately adjusting the content thereof at a level that does not affect the ultraviolet curability.

The corrected breaking strength of the first hard coating layer can be easily adjusted within the range of 50 to 500 MPa by adjusting the types of the isocyanate compound and the acrylate compound having a hydroxy group used for producing the urethane acrylate oligomer and the number of moles thereof, or adjusting the amount of the urethane acrylate oligomer, the photoinitiator, and the solvent.

In one embodiment of the present invention, the second hard coating layer may be formed from a second hard coating layer-forming composition including a photocurable resin, inorganic nanoparticles, a photoinitiator and a solvent.

The photocurable resin may include a photocurable (meth)acrylate oligomer and/or a photocurable monomer.

The photocurable (meth)acrylate oligomer may include at least one selected from the group consisting of epoxy (meth)acrylate, urethane (meth)acrylate and polyester (meth)acrylate.

The epoxy (meth)acrylate can be prepared by reacting an epoxy compound with a carboxylic acid having a (meth)acryloyl group.

Specific examples of the epoxy compound include glycidyl (meth)acrylate, glycidyl ethers of C₁-C₁₂ linear alcohols at both terminal ends, diethylene glycol diglycidyl ether, tripropylene glycol diglycidyl ether, bisphenol A diglycidyl ether, ethylene oxide modified bisphenol A diglycidyl ether, propylene oxide modified bisphenol A diglycidyl ether, trimethylol propane triglycidyl ether, pentaerythritol tetraglycidyl ether, hydrogenated bisphenol A diglycidyl ether, glycerin diglycidyl ether, and the like.

Examples of the carboxylic acid having a (meth)acryloyl group include (meth)acrylic acid, 2-(meth)acryloyloxyethylsuccinic acid, 2-(meth)acryloyloxyethylhexahydrophthalic acid and the like.

The urethane (meth)acrylate can be prepared by reacting a polyfunctional (meth)acrylate having a hydroxy group in its molecule and a compound having an isocyanate group in its molecule in the presence of a catalyst.

Specific examples of the polyfunctional (meth)acrylate having a hydroxy group in the molecule include at least one selected from the group consisting of 2-hydroxyethyl (meth)acrylate, 2-hydroxyisopropyl (meth)acrylate, 4-hydroxybutyl (meth)acrylate, caprolactone ring-opened hydroxy acrylate, a mixture of pentaerythritol tri/tetra(meth)acrylate, a mixture of dipentaerythritol penta/hexa(meth)acylate, and the like.

Specific examples of the compound having an isocyanate group in the molecule include at least one selected from the group consisting of trifunctional isocyanates derived from 1,4-diisocyanatobutane, 1,6-diisocyanatohexane, 1,8-diisocyanatooctane, 1,12-diisocyanatododecane, 1,5-diisocyanato-2-methylpentane, trimethyl-1,6-diisocyanatohexane, 1,3-bis(isocyanatomethyl)cyclohexene, trans-1,4-cyclohexene diisocyanate, 4,4′-methylenebis(cyclohexyl isocyanate), isophorone diisocyanate, toluene-2,4-diisocyanate, toluene-2,6-diisocyanate, xylene-1,4-diisocyanate, tetramethylxylene-1,3-diisocyanate, I-chloromethyl-2,4-diisocyanate, 4,4′-methylenebis(2,6-dimethylphenyl isocyanate), 4,4′-oxybis(phenylisocyanate), hexamethylene diisocyanate, and an adduct of trimethylol propane and toluene diisocyanate.

Specific examples of the polyester (meth)acrylate include diacrylates such as ethylene glycol di(meth)acrylate, diethylene glycol di(meth)acrylate, triethylene glycol di(meth)acrylate, polyethylene glycol di(meth)acrylate, propylene glycol di(meth)acrylate, dipropylene glycol di(meth)acrylate, tripropylene glycol di(meth)acrylate, 1,4-butanediol di(meth)acrylate, neopentyl glycol di(meth)acrylate, 1,6-hexanediol di(meth)acrylate, tricyclodecane di(meth)acrylate, bisphenol A di(meth)acrylate; trimethylolpropane tri(meth)acrylate, pentaerythritol tri(meth)acrylate, pentaerythritol tetra(meth)acrylate, ditrimethylolpropane tetra(meth)acrylate, dipentaerythritol penta(meth)acrylate, dipentaerythritol hexa(meth)acrylate, tris(2-(meth)acryloyloxy ethyl)isocyanurate, and the like.

As the photocurable monomer, monomers used in the art having unsaturated groups as photocurable functional groups commonly used in the art such as a (meth)acryloyl group, a vinyl group, a styryl group, an allyl group and the like in the molecule can be used without limitation, and specifically, a monomer having a (meth)acryloyl group can be used.

Examples of the monomer having a (meth)acryloyl group include at least one selected from the group consisting of neopentyl glycol acrylate, 1,6-hexanediol (meth)acrylate, propylene glycol di(meth)acylate, triethylene glycol di(meth)acrylate, dipropylene glycol di(meth)acrylate, polyethylene glycol di(meth)acrylate, polypropylene glycol di(meth)acrylate, trimethylolpropane tri(meth)acrylate, trimethylolethane tri(meth)acrylate, 1,2,4-cyclohexane tetra(meth)acrylate, pentaglycerol tri(meth)acrylate, pentaerythritol tetra(meth)acrylate, pentaerythritol tri(meth)acrylate, dipentaerythritol tri(meth)acrylate, dipentaerythritol penta(meth)acrylate, dipentaerythritol tetra(meth)acrylate, dipentaerythritol hexa(meth)acrylate, tripentaerythritol tri(meth)acrylate, tripentaerythritol hexa(meth)acrylate, bis(2-hydroxyethyl)isocyanurate di(meth)acrylate, hydroxyethyl (meth)acrylate, hydroxypropyl (meth)acrylate, hydroxybutyl (meth)acrylate, isooctyl (meth)acrylate, isodecyl (meth)acrylate, stearyl (meth)acrylate, tetrahydrofurfuryl (meth)acrylate, phenoxyethyl (meth)acrylate, and isobornyl (meth)acrylate, but are not limited thereto.

The photocurable resin may be contained in an amount of 15 to 85% by weight, preferably 25 to 60% by weight based on 100% by weight of the total weight of the second hard coating layer-forming composition. When the content of the photocurable resin is less than 15% by weight, it may be difficult to increase the coating thickness, and it may be difficult to secure sufficient mechanical properties. When the content of the photocurable resin exceeds 85% by weight, the coating property may be remarkably deteriorated, resulting in defective appearance and making it difficult to ensure thickness uniformity.

The inorganic nanoparticles may have an average particle size of 1 to 100 nm, preferably 5 to 50 nm. These inorganic nanoparticles can be uniformly formed in the coating film to increase mechanical properties such as abrasion resistance, scratch resistance and pencil hardness. If the particle size is less than the above range, aggregation occurs in the composition, and thus a uniform coating film cannot be formed and the above effect cannot be expected. Conversely, if the particle size exceeds the above range, not only the optical properties of the finally obtained coating film may be lowered but also the mechanical properties may be deteriorated.

These inorganic nanoparticles can be metal oxides, and one selected from the group consisting of Al₂O₃, SiO₂, ZnO, ZrO₂, BaTiO₃, TiO₂, Ta₂O₅, Ti₃O₅, ITO, IZO, ATO, ZnO—Al, Nb₂O₃, SnO and MgO can be used. Particularly, Al₂O₃, SiO₂, ZrO₂ and the like can be used.

The inorganic nanoparticles can be produced directly or commercially available. In the case of commercially available products, those dispersed in an organic solvent at a concentration of 10 to 80% by weight can be used.

The inorganic nanoparticles may be contained in an amount of 1 to 70% by weight, for example 10 to 50% by weight, based on 100% by weight of the total weight of the second hard coating layer-forming composition. When the amount of the inorganic nanoparticles is less than 1% by weight, the effect of improving the hardness may be insignificant, and when the amount of the inorganic nanoparticles exceeds 70% by weight, cracks can occur in the cured surface.

The kinds and contents of a photoinitiator, a solvent, and additional components such as a leveling agent, a ultraviolet stabilizer, a heat stabilizer and the like, which are used in the second hard coating layer-forming composition, are the same as those used in the first hard coating layer-forming composition, and thus the description thereof will be omitted.

A hard coating film according to an embodiment of the present invention can be prepared by coating a first hard coating layer-forming composition onto one surface of a transparent substrate followed by curing to form a first hard coating layer, and coating a second hard coating layer-forming composition onto the other surface of the transparent substrate followed by curing to form a second hard coating layer.

As the transparent substrate, any polymer film having transparency can be used without limitation. The polymer film can be produced by a film-forming method or an extrusion method according to a molecular weight and a production method of a film, and can be used without particular limitation as long as it is a commercially available transparent polymer film. Examples thereof include various transparent polymer substrates such as triacetyl cellulose, acetyl cellulose butyrate, ethylene-vinyl acetate copolymer, propionyl cellulose, butyryl cellulose, acetyl propionyl cellulose, polyester, polystyrene, polyamide, polyether imide, polyacryl, polyimide, polyether sulfone, polysulfone, polyethylene, polypropylene, polymethyl pentene, polyvinyl chloride, polyvinylidene chloride, polyvinyl alcohol, polyvinyl acetal, polyether ketone, polyether ether ketone, polymethyl methacrylate, polyethylene terephthalate, polybutylene terephthalate, polyethylene naphthalate, polycarbonate, and the like.

The thickness of the substrate film is not particularly limited, but may be 10 to 1000 μm, particularly 20 to 150 μm. When the thickness of the substrate film is less than 10 μm, the strength of the film is lowered and thus the workability is lowered. When the thickness of the substrate film is more than 1000 μm, the transparency is lowered or the weight of the hard coating film is increased.

The first and second hard coating compositions may be coated onto the transparent substrate by suitably using a known coating process such as die coater, air knife, reverse roll, spray, blade, casting, gravure, micro gravure, spin coating, etc.

After the first and second hard coating compositions are coated onto the transparent substrate, a drying process may be carried out by vaporizing volatiles at a temperature of 30 to 150° C. for 10 seconds to one hour, more specifically 30 seconds to 30 minutes, followed by UV curing. The UV curing may be carried out by the irradiation of UV-rays at about 0.01 to 10 J/cm², particularly 0.1 to 2 J/cm².

At this time, the thickness of the first hard coating layer formed through the above process may be particularly 50 to 300 μm, and more particularly 100 to 200 μm. When the thickness of the first hard coating layer is within the above range, the impact resistance is excellent and the bending performance is improved due to an appropriate thickness.

In addition, the thickness of the second hard coating layer may be particularly 2 to 30 μm, more particularly 3 to 20 μm. When the thickness of the second hard coating layer is within the above range, an excellent hardness effect can be obtained.

One embodiment of the present invention relates to an image display device having the above-described hard coating film. For example, the hard coating film of the present invention may be used as a window of an image display device, especially a flexible display device. Further, the hard coating film of the present invention may be used by being attached to a polarizing plate, a touch sensor, or the like.

The hard coating film according to one embodiment of the present invention may be used in liquid crystal devices (LCDs) of various operation modes, including reflective, transmissive, transflective, twisted nematic (TN), super-twisted nematic (STN), optically compensated bend (OCB), hybrid-aligned nematic (HAN), vertical alignment (VA)-type and in-plane switching (IPS) LCDs. Also, the hard coating film according to one embodiment of the present invention may be used in various image display devices, including plasma displays, field emission displays, organic EL displays, inorganic EL displays, electronic paper and the like.

Hereinafter, the present invention will be described in more detail with reference to examples, comparative examples and experimental examples. It should be apparent to those skilled in the art that these examples, comparative examples and experimental examples are for illustrative purposes only, and the scope of the present invention is not limited thereto.

### Preparation Example 1: Preparation of First Hard Coating Layer-Forming Composition

58.2% by weight of bifunctional urethane acrylate (UA-232P, Shin-Nakamura Chemical), 40% by weight of methyl ethyl ketone, 1.0% by weight of a photoinitiator (1-hydroxycyclohexyl phenyl ketone), 0.5% by weight of a photoinitiator (diphenyl (2,4,6-trimethylbenzoyl)-phosphine oxide) and 0.3% by weight of a leveling agent (BYK-UV 3570, BYK Chemie) were mixed using a stirrer and filtered with a polypropylene (PP) filter to prepare a hard coating composition.

### Preparation Example 2: Preparation of First Hard Coating Layer-Forming Composition

58.5% by weight of bifunctional urethane acrylate (UF 8001G, KYOEISA Chemical), 40% by weight of methyl ethyl ketone, 1.0% by weight of a photoinitiator (1-hydroxycyclohexyl phenyl ketone), and 0.5% by weight of a photoinitiator (diphenyl (2,4,6-trimethylbenzoyl)-phosphine oxide) were mixed using a stirrer and filtered with a polypropylene (PP) filter to prepare a hard coating composition.

### Preparation Example 3: Preparation of First Hard Coating Layer-Forming Composition

59.0% by weight of bifunctional urethane acrylate (SC 2404, Miwon Specialty Chemicals), 40% by weight of methyl ethyl ketone, and 1.0% by weight of a photoinitiator (1-hydroxycyclohexyl phenyl ketone) were mixed using a stirrer and filtered with a polypropylene (PP) filter to prepare a hard coating composition.

### Preparation Example 4: Preparation of First Hard Coating Layer-Forming Composition

70% by weight of bifunctional urethane acrylate (UA-122P, Shin-Nakamura Chemical), 25% by weight of methyl ethyl ketone, 4.5% by weight of a photoinitiator (1-hydroxycyclohexyl phenyl ketone), and 0.5% by weight of a leveling agent (BYK-3570, BYK Chemie) were mixed using a stirrer and filtered with a polypropylene (PP) filter to prepare a hard coating composition.

### Preparation Example 5: Preparation of Second Hard Coating Layer-Forming Composition

38% by weight of methyl ethyl ketone, 30% by weight of methyl ethyl ketone silica sol (MEK-AC-2140Z, Nissan Chemical Industries, particle diameter: 10 to 15 nm), 30% by weight of a trifunctional monomer (M340, Miwon Specialty Chemicals), 1.0% by weight of a photoinitiator (1-hydroxycyclohexyl phenyl ketone) and 1.0% by weight of a leveling agent (BYK-3570, BYK Chemie) were mixed using a stirrer and filtered with a polypropylene (PP) filter to prepare a hard coating composition.

### Examples 1 to 2 and Comparative Examples 1 to 2: Preparation of Hard Coating Film

### Example 1

After the first hard coating layer-forming composition prepared in Preparation Example 1 was coated onto one surface of a polyimide substrate so as to have a thickness after drying of 60 μm, the solvent was dried at 80 (for 5 minutes and then the composition was cured by irradiating with an integrated amount (1.5 J/cm²) of ultraviolet. The above procedure was repeated three times to obtain a first hard coating layer having a thickness after drying of 180 μm. Then, the second hard coating layer-forming composition prepared in Preparation Example 5 was coated on the other surface of the polyimide substrate so as to have a thickness after drying of 10 μm, the solvent was dried at 80° C. for 2 minutes, and the composition was cured by irradiating with an integrated amount (0.5 J/cm²) of ultraviolet to obtain a second hard coating layer. A hard coating film of Example 1 was produced through the above preparation method.

### Example 2

A hard coating film was prepared in the same manner as in Example 1, except that the first hard coating layer-forming composition prepared in Preparation Example 2 was used instead of the first hard coating layer-forming composition prepared in Preparation Example 1.

### Comparative Example 1

A hard coating film was prepared in the same manner as in Example 1, except that the first hard coating layer-forming composition prepared in Preparation Example 3 was used instead of the first hard coating layer-forming composition prepared in Preparation Example 1.

### Comparative Example 2

A hard coating film was prepared in the same manner as in Example 1, except that the first hard coating layer-forming composition prepared in Preparation Example 4 was used instead of the first hard coating layer-forming composition prepared in Preparation Example 1.

### Experimental Example 1

### Experimental Example 1-1

After the first hard coating layer-forming compositions prepared in Preparation Examples 1 to 4 were each coated onto one surface of a ZF-14 film (Zeon Corporation) having a thickness of 40 μm, the solvent was dried at 80° C. for 5 minutes, and the composition was cured by irradiating with an integrated amount (1.5 J/cm²) of ultraviolet. The above procedure was repeated three times to obtain a first hard coating layer having a thickness after drying of 180 μm. Then, the stress-strain curve of the first hard coating layer obtained by careful peeling was measured using a universal testing machine (UTM) according to ASTM D 882. Then, the corrected breaking strength was derived from the elastic modulus and breaking elongation derived from the stress-strain curve according to the following equation 1.

Corrected Breaking Strength (MPa)=Elastic Modulus (MPa)×Breaking Elongation (%)× 1/100 [Equation 1]

The derived corrected breaking strength is shown in Table 1 below.

TABLE 1

| | Preparation | Preparation | Preparation | Preparation |
|---|---|---|---|---|
| Classification | Example 1 | Example 2 | Example 3 | Example 4 |
| Corrected | 251.0 | 70.0 | 9.6 | 673.7 |
| breaking | | | | |
| strength (MPa) | | | | |
| Breaking | 101.8 | 74.8 | 80.4 | 67.8 |
| elongation (%) | | | | |
| Elastic | 246.4 | 93.6 | 12.0 | 993.7 |
| modulus (MPa) | | | | |

### Experimental Example 1-2

The physical properties of the hard coating films prepared in Examples and Comparative Examples were measured by the following methods, and the results are shown in Table 2 below.

(1) Bending Resistance at Room Temperature

The hard coating film was folded in half so that the distance between the film surfaces was 6 mm, and then allowed to stand for 24 hours. Next, when the film was spread again, it was confirmed with the naked eye whether or not cracks occurred in the folded portion, and thereby the bending resistance at room temperature was evaluated. The results are shown as follows.

<Evaluation Criteria>

O: No occurrence of crack in the folded portion

X: Occurrence of cracks in the folded portion

(2) Bending Resistance at High Temperature-High Humidity

The hard coating film was folded in half so that the distance between the film surfaces was 6 mm, and then allowed to stand for 24 hours at 85° C. and 85% relative humidity. Next, it was confirmed whether or not the film had defects, and thereby the bending resistance at high temperature-high humidity was evaluated. The results are shown as follows.

<Evaluation Criteria>

O: No occurrence of crack in the folded portion

X: Occurrence of cracks in the folded portion

(3) Impact Resistance (Ball Drop Test)

Glass Breakage

The first hard coating layer of the hard coating film was bonded to a glass with 25 μm OCA (elastic modulus: 0.08 MPa), and then a 50 g steel ball was dropped 5 times from a height of 50 cm to check whether the glass at the lower part of the film was broken. The results are described as follows.

<Evaluation Criteria>

O: No occurrence of glass breakage at least three times in five tests

X: Occurrence of glass breakages at least three times in five tests

Occurrence of Hit Marks on Surface

When the ball drop evaluation was performed, it was confirmed whether or not the second hard coating layer was broken or pressing marks occurred thereon by a steel ball. The results are described as follows.

<Evaluation Criteria>

O: Absence of a trace of breakage and pressing mark on the second hard coating layer at least three times in five tests

X: Presence of a trace of breakage and pressing mark on the second hard coating layer at least three times in five tests

TABLE 2

| | | | Bending property | |
|---|---|---|---|---|
| | | | | Bending |
| | Impact resistance | | | resistance at |
| | | Occurrence | Bending | high |
| | | of hit | resistance | temperature- |
| | Glass | marks on | at room | high |
| | breakage | surface | temperature | humidity |
| Example 1 | ◯ | ◯ | ◯ | ◯ |
| Example 2 | ◯ | ◯ | ◯ | ◯ |
| Comparative | ◯ | X | ◯ | X |
| Example 1 | | | | |
| Comparative | X | ◯ | X | ◯ |
| Example 2 | | | | |

As can be seen from Table 2, it was confirmed that the hard coating films of Examples 1 and 2 according to the present invention having the first hard coating layer in which the corrected breaking strength was 50 to 500 MPa exhibited excellent impact resistance as well as excellent bending resistance. On the other hand, it was confirmed that the hard coating films of Comparative Examples 1 and 2 in which the corrected breaking strength was out of the range of 50 to 500 MPa could not simultaneously ensure impact resistance and bending resistance.

Although particular embodiments of the present invention have been shown and described in detail, it will be obvious to those skilled in the art that these specific techniques are merely preferred embodiments, and various changes and modifications may be made to the invention without departing from the spirit and scope of the invention.

The substantial scope of the present invention, therefore, is to be defined by the appended claims and equivalents thereof.

1. A hard coating film, comprising:
a substrate;
a first hard coating layer formed on one surface of the substrate; and
a second hard coating layer formed on the other surface of the substrate,
wherein the first hard coating layer has a corrected breaking strength defined by the following Equation 1 of 50 to 500 MPa:
Corrected Breaking Strength (MPa)=Elastic Modulus (MPa)×Breaking Elongation (%)× 1/100 [Equation 1]
wherein,
the elastic modulus represents the modulus of elasticity in the stress-strain curve, and
the breaking elongation represents the elongation at break in the stress-strain curve.

2. The hard coating film of claim 1, wherein the first hard coating layer is formed from a first hard coating layer-forming composition including a urethane acrylate oligomer, a photoinitiator and a solvent.

3. The hard coating film of claim 2, wherein the urethane acrylate oligomer is a bifunctional urethane acrylate oligomer.

4. The hard coating film of claim 1, wherein the second hard coating layer is formed from a second hard coating layer-forming composition including a photocurable resin, inorganic nanoparticles, a photoinitiator and a solvent.

5. An image display device having the hard coating film of claim 1.

6. A window of a flexible display device having the hard coating film of claim 1.

7. A polarizing plate having the hard coating film of claim 1.

8. A touch sensor having the hard coating film of claim 1.

9. An image display device having the hard coating film of claim 2.

10. An image display device having the hard coating film of claim 3.

11. An image display device having the hard coating film of claim 4.

12. A window of a flexible display device having the hard coating film of claim 2.

13. A window of a flexible display device having the hard coating film of claim 3.

14. A window of a flexible display device having the hard coating film of claim 4.

15. A polarizing plate having the hard coating film of claim 2.

16. A polarizing plate having the hard coating film of claim 3.

17. A polarizing plate having the hard coating film of claim 4.

18. A touch sensor having the hard coating film of claim 2.

19. A touch sensor having the hard coating film of claim 3.

20. A touch sensor having the hard coating film of claim 4.
